(19) United States
(12) Patent Application Publication
(10) Pub. No.: US 2015/0262583 A1
(43) Pub. Date: Sep. 17, 2015

(54) INFORMATION TERMINAL AND VOICE OPERATION METHOD

(71) Applicant: KYOCERA Corporation, Kyoto-shi, Kyoto (JP)

(72) Inventors: Atsuhiko Kanda, Yokohama-shi (JP); Hayato Takenouchi, Kizugawa-shi (JP)

(73) Assignee: KYOCERA Corporation, Kyoto-shi, Kyoto (JP)

(21) Appl. No.: 14/431,728

(22) PCT Filed: Sep. 17, 2013
(86) PCT No.: PCT/JP2013/074975

§ 371 Date: Mar. 26, 2015

(30) Foreign Application Priority Data
Sep. 26, 2012 (JP) 2012-211731

(51) Int. Cl. G10L 17/22; G06F 17/30

(52) U.S. Cl. CPC G10L 17/22; G06F 17/30864

(57) ABSTRACT

A mobile phone 10 is installed with a plurality of applications, and an arbitrary operation by a voice input can be performed. The mobile phone 10 stores a history of an application performed by a user in a RAM (46). If the user performs a voice input saying “Use camera”, “standard camera” and “AR camera” that are applications in a category of “camera” are acquired as a search result. At this time, the search result is narrowed down based on a use history of the user. If a use frequency of “standard camera” is higher than that of “AR camera”, “standard camera” is performed.

### FIELD OF ART

The invention relates to an information terminal and voice operation method, and more specifically, an information terminal capable of operating with a voice input and a voice operation method.

### BACKGROUND ART

An information terminal that can be operated by a voice input is known. In a certain voice recognition/response type mobile phone, a user can arbitrarily perform a telephone calling function, a mail function, etc. by a voice operation.

### SUMMARY OF THE INVENTION

### Problems to be Solved by the Invention

In a recent mobile phone, a user can install an arbitrary application in the mobile phone freely. In such a case, similar applications may be installed in plural, and a following problem occurs.

Even if a voice input saying “Start camera” is performed as a voice operation, for example, since there are applications concerning a camera in plural, the mobile phone cannot determine which application should be performed.

Therefore, a primary object of the invention is to provide a novel information terminal and voice operation method.

Another object of the invention is to provide an information terminal and voice operation method, having high convenience of a voice operation.

### Means for Solving a Problem

A first aspect of the invention is an information terminal that an operation by a voice input is possible, comprising: a storage module operable to store a plurality of applications and a use history of each of the applications; an acquisition module operable to acquire specific information for specifying an application to be performed based on an input voice; a narrowing-down module operable to narrow down, based on the use history, the specific information that is acquired; and a performing module operable to perform an application based on a result that is narrowed down by the narrowing-down module.

A second aspect of the invention is a voice operation method in an information terminal that comprises a storage module operable to store a plurality of applications and a use history of each of the applications, and an operation by a voice input is possible, a processor of the information terminal performing: acquiring specific information for specifying an application to be performed based on an input voice; narrowing-down, based on the use history, the specific information that is acquired; and performing an application based on a result that is narrowed down.

### Advantage of the Invention

According to the invention, it is possible to increase convenience of a voice operation.

The above described objects and other objects, features, aspects and advantages of the invention will become more apparent from the following detailed description of the invention when taken in conjunction with the accompanying drawings.

### BRIEF DESCRIPTION OF THE DRAWINGS

FIG. 1 shows an appearance of a mobile phone of an embodiment according to the invention, wherein FIG. 1(A) shows an appearance of a main surface of the mobile phone and FIG. 1(B) shows an appearance of another surface of the mobile phone.

FIG. 2 is a schematic view showing electrical structure of the mobile phone shown in FIG. 1.

FIG. 3 is a schematic view showing an example of a format of a local database stored in a RAM shown in FIG. 1.

FIG. 4 is a schematic view showing an example of a format of use history data stored in the RAM shown in FIG. 1.

FIG. 5 is a schematic view showing an example of a format of an application table stored in the RAM shown in FIG. 1.

FIG. 6 is a schematic view showing an example of a standby screen displayed on a display shown in FIG. 1.

FIG. 7 shows an example of a voice operation performed using a microphone and a speaker shown in FIG. 1, wherein FIG. 7(A) shows a state where a voice operation function is effective, FIG. 7(B) shows an example of a state where a voice operation is performed, and FIG. 7(C) shows an example of a state where a standard camera is performed by the voice operation.

FIG. 8 shows another example of a voice operation performed using a microphone and a speaker shown in FIG. 1, wherein FIG. 8(A) shows a state where a voice operation function is effective, FIG. 8(B) shows another example of a state where a voice operation is performed, and FIG. 8(C) shows an example of a state where a candidate list is displayed.

FIG. 9 is a schematic view showing an example of a memory map of a RAM shown in FIG. 2.

FIG. 10 is a flowchart showing an example of history record processing by a processor shown in FIG. 2.

FIG. 11 is a flowchart showing an example of a part of voice operation processing by the processor shown in FIG. 2.

FIG. 12 is a flowchart showing an example of another part of the voice operation processing by the processor shown in FIG. 2, following FIG. 11.

FIG. 13 is a flowchart showing an example of the other part of the voice operation processing by the processor shown in FIG. 2, following FIG. 12.

FIG. 14 is a schematic view showing an example of a format of browsing history data stored in the RAM shown in FIG. 1.

FIG. 15 is a schematic view showing an example of a format of a URL table stored in the RAM shown in FIG. 1.

FIG. 16 shows a further example of a voice operation performed using a microphone and a speaker shown in FIG. 1, wherein FIG. 16(A) shows a state where a voice operation function is effective, FIG. 16(B) shows a further example of a state where a voice operation is performed, and FIG. 16(C) shows an example of a state where a browsing function is performed by the voice operation.

FIG. 17 is a schematic view showing an example of a part of the memory map of the RAM shown in FIG. 2.

FIG. 18 is a further example of the voice operation processing by the processor shown in FIG. 2.

### FORMS FOR EMBODYING THE INVENTION

### First Embodiment

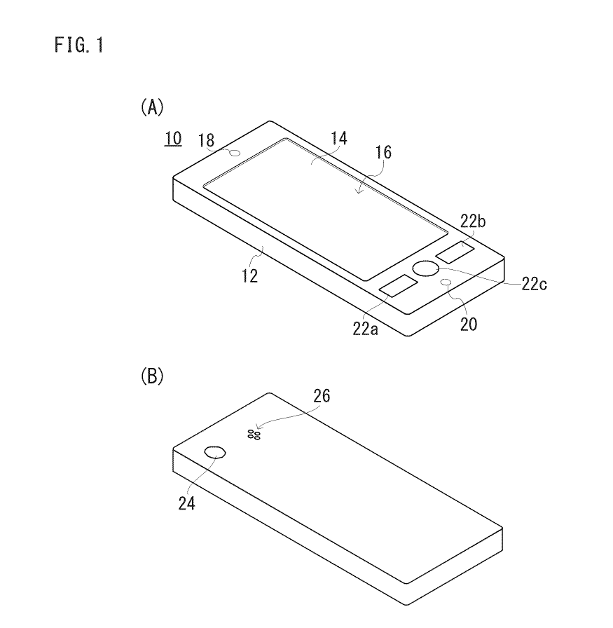

With referring to FIGS. 1(A) and 1(B), a mobile phone 10 of an embodiment according to the invention is a smartphone as an example, and includes a longitudinal flat rectangular housing 12. However, it is pointed out in advance that the invention can be applied to an arbitrary information terminal such as a tablet terminal, a PDA, a navigation terminal, etc.

A display 14 such as a liquid crystal, organic EL, etc. called a display module is provided on a main surface (front surface) of the housing 12. A touch panel 16 is provided on the display 14.

A first speaker 18 is housed in the housing 12 at one end of a longitudinal direction on a side of the main surface, and a microphone 20 is housed at the other end in the longitudinal direction on the side of the main surface.

As hardware keys that constitute an input operating module together with the touch panel 16, a call key 22a, an end key 22b and a menu key 22c are provided on the main surface of the housing 12, in this embodiment.

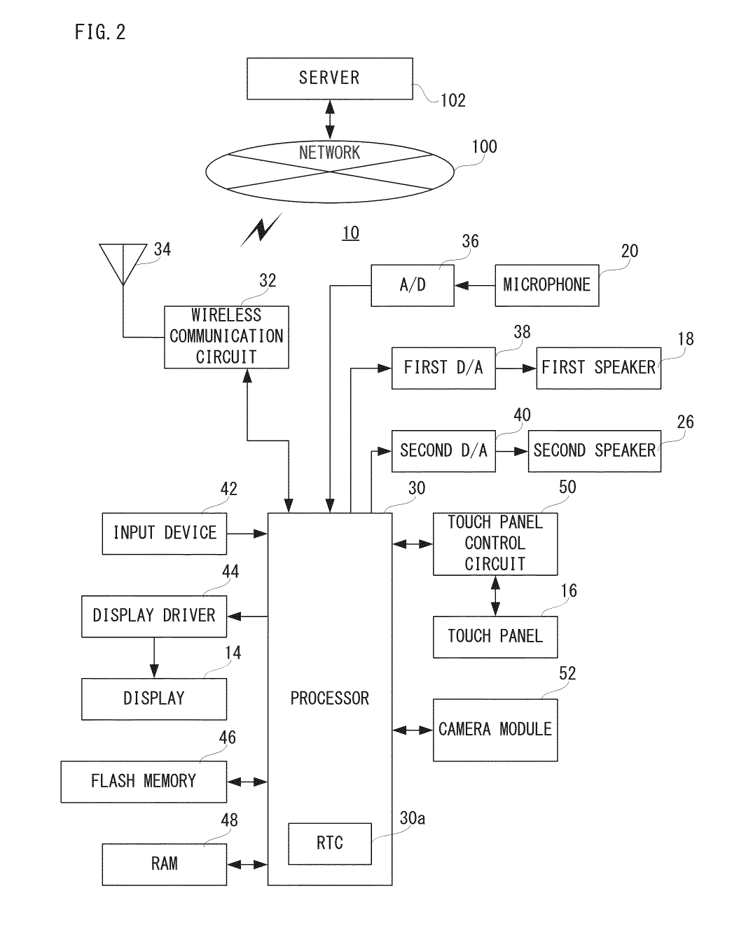

A lens aperture 24 that communicates with a camera module 52 (see FIG. 2) is provided at one end of the longitudinal direction on rear surface (another surface) of the housing 12. Furthermore, a second speaker 26 is housed at a side of the rear surface of the housing 12.

For example, a user can input a telephone number by performing a touch operation by the touch panel 16 to a dial key (not shown) displayed on the display 14, and start a telephone conversation by operating the call key 22a. If operating the end key 22b, the telephone conversation can be ended. In addition, by long-depressing the end key 22b, it is possible to turn on/off a power supply of the mobile phone 10.

If operating the menu key 22c, a menu screen is displayed on the display 14, and in such a state, by performing a touch operation by means of the touch panel 16 to software keys, menu icons, etc. being displayed on the display 14, it is possible to perform a desired function.

Furthermore, although details will be described later, if a camera function is performed, the camera module 52 is started and a preview image (through image) corresponding to a photographic subject is displayed on the display 14. Then, the user can image the photographic subject by turning the rear surface that the lens aperture 24 is provided to the photographic subject and performing an imaging operation.

Furthermore, a plurality of applications are installed in the mobile phone 10. First, a standard camera and an AR (Augmented Reality) camera are installed as applications of a camera system. The standard camera is an application that is pre-installed in the mobile phone 10 and saves an image in response to an imaging operation. The AR camera is an application that is arbitrarily installed by a user and displays information while superposed on a through image.

Furthermore, as application of an email system, an E-mail, an SMS (Short Message Service) and an MMS (Multimedia Message Service) are installed.

Furthermore, applications such as a browser, an address book, a schedule, time, a music player, a video player, etc. are also installed, and the user can arbitrarily start such an application.

With referring to FIG. 2, the mobile phone 10 of the embodiment shown in FIG. 1 includes a processor 30 that is called as a computer or a CPU. The processor 30 is connected with a wireless communication circuit 32, an A/D converter 36, a first D/A converter 38, a second D/A converter 40, an input device 42, a display driver 44, a flash memory 46, a RAM 48, a touch panel control circuit 50, the camera module 52, etc.

The wireless communication circuit 32 is wirelessly connected with a network 100 (communication network, telephone network). A server 102 is connected with the network 100 via a wire or wirelessly.

The processor 30 is in charge of entire control of the mobile phone 10. The processor 30 includes an RTC 30a that outputs date and time information. A whole or part of a program that is set in advance in the flash memory 46 is, in use, developed or loaded into the RAM 48 that functions as a storing module, and the processor 30 operates in accordance with the program developed in the RAM 48. In addition, the RAM 48 is further used as a working area or buffer area for the processor 30.

The input device 42 includes the hardware keys 22a-22c shown in FIG. 1, and thus constitutes an operation module or input module. Information (key data) of the hardware key that the user operates is input to the processor 30.

The wireless communication circuit 32 is a circuit for sending and receiving a radio wave for a telephone conversation, a mail, etc. via an antenna 34. In this embodiment, the wireless communication circuit 32 is a circuit for performing a wireless communication with a CDMA system. For example, if the user designates an outgoing call (telephone call) using the input device 42, the wireless communication circuit 32 performs telephone call processing under instructions from the processor 30 and outputs a telephone call signal via the antenna 34. The telephone call signal is sent to a telephone at the other end of line through a base station and a communication network. Then, when incoming call processing is performed in the telephone at the other end of line, a communication-capable state is established and the processor 30 performs telephonic communication processing.

The microphone 20 shown in FIG. 1 is connected to the A/D converter 36. A voice signal from the microphone 20 is input to the processor 30 as digital voice data through the A/D converter 36. The first speaker 18 is connected to the first D/A converter 38, and the second speaker 26 is connected to the second D/A converter 40. The first D/A converter 38 and the second D/A converter 40 convert digital voice data into voice signals to apply to the first speaker 18 and the second speaker 26 via amplifiers. Therefore, voices of the voice data are output from the first speaker 18 and the second speaker 26. Then, in a state where the telephone conversation processing is performed, a voice that is collected by the microphone 20 is transmitted to the telephone at the other end of line, and a voice that is collected by the telephone at the other end of line is output from the first speaker 18. In addition, a ringtone or a voice for a voice operation described later is output from the second speaker 26.

The display driver 44 is connected to the display 14 shown in FIG. 1, and therefore, the display 14 displays an image or video in accordance with image or video data that is output from the processor 30. That is, the display driver 44 controls display by the display 14 that is connected to the display driver 44 under instructions by the processor 30. In addition, the display driver 44 includes a video memory that temporarily stores the image or video data to be displayed. The display 14 is provided with a backlight that includes a light source of an LED or the like, for example, and the display driver 42 controls, according to the instructions from the processor 30, brightness, turning on/off of the backlight.

The touch panel 16 shown in FIG. 1 is connected to the touch panel control circuit 50. The touch panel control circuit 50 applies to the touch panel 16 a necessary voltage or the like and inputs to the processor 30 a touch start signal indicating a start of a touch by the user to the touch panel 16, a touch end signal indicating an end of a touch by the user, and coordinate data indicating a touch position that the user touches. Therefore, the processor 30 can determine the user touches to which icon or key based on the coordinate data.

In the embodiment, the touch panel 16 is of an electrostatic capacitance system that detects a change of an electrostatic capacitance between electrodes, which occurs when an object such as a finger is in close to a surface of the touch panel 16. The touch panel 16 detects that one or more fingers are brought into contact with the touch panel 16, for example. Therefore, the touch panel 16 is also called a pointing device. The touch panel control circuit 50 functions as a detecting module, and detects a touch operation within a touch-effective range of the touch panel 16, and outputs coordinate data indicative of a position of the touch operation to the processor 30. That is, the user inputs to the mobile phone 10 an operation position, an operation direction and so on through a touch operation to the surface of the touch panel 16. In addition, the touch operation in this embodiment includes a tap operation, a long-tap operation, a flick operation, a slide operation, etc.

The camera module 52 includes a control circuit, a lens, an image sensor, etc. The processor 30 starts the control circuit and the image sensor if an operation for performing a camera function is performed. Then, if image data based on a signal that is output from the image sensor is input to the processor 30, a preview image according to a photographic subject is displayed on the display 14.

Furthermore, the mobile phone 10 has a voice recognition function that recognizes a voice that is input to the microphone 20, an utterance function that outputs a voice message based on a database of synthesized voices and a voice operation function using these functions. Then, the voice operation function of this embodiment is supports a voice input of a natural language.

If a user inputs a voice saying “Call the home” to a mobile phone 10 that the voice operation function is performed, a voice of the user is recognized by the voice recognition function. Furthermore, the mobile phone 10 outputs a response message saying “Call the home?” based on a recognized voice by the utterance function. At this time, if the user replies by saying “Call”, the mobile phone 10 reads the telephone number that is registered as the home from an address book, and call to that telephone number. If the voice operation function is thus performed, the user can operate the mobile phone 10 without performing a touch operation to the touch panel 16. Then, it becomes for the user easy to grasp a state of the mobile phone 10 by hearing the contents of voice guidance (response messages).

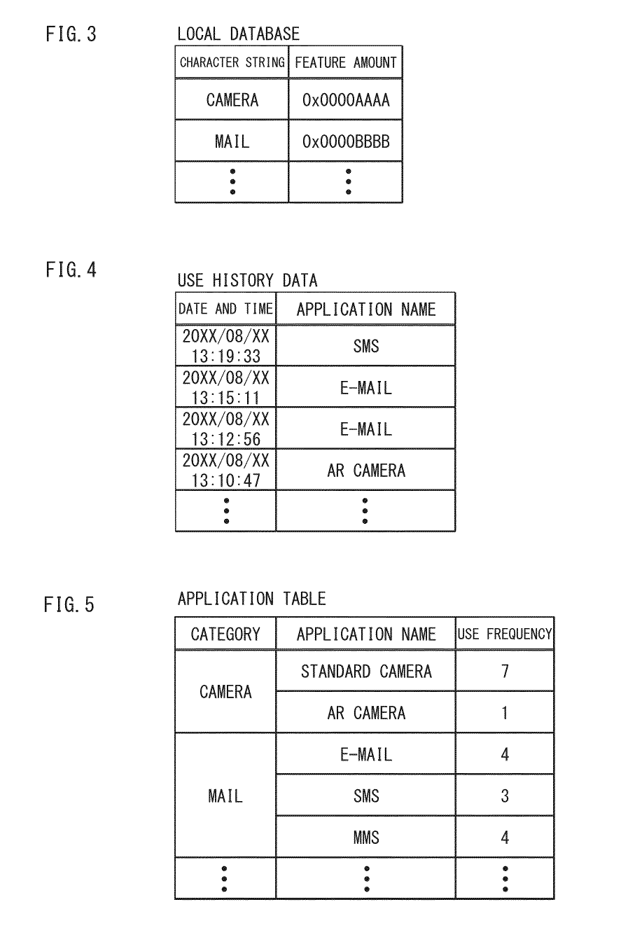

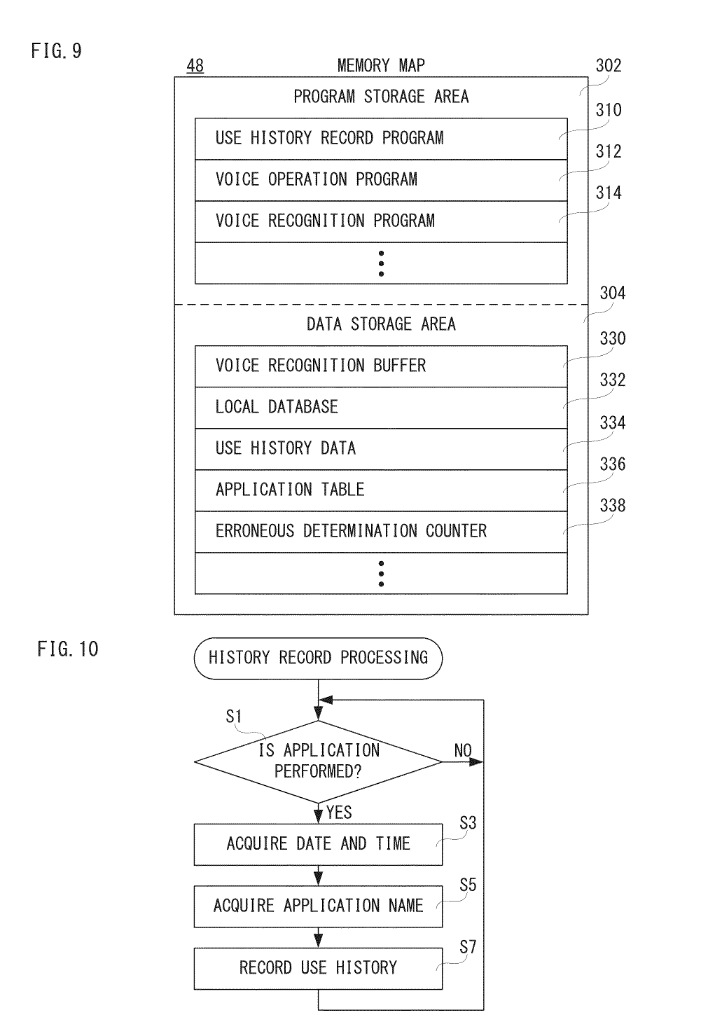

FIG. 3 shows a local database 332 (see FIG. 9) for recognizing an input voice. With reference to FIG. 3, the local database 332 includes a column of character string and a column of feature amount. Character strings such as “camera” and “mail”, etc. are recorded in the column of character string, for example, and the contents of corresponding feature amounts are indicated. Memory addresses indicating locations where the feature amounts are stored are recorded in the column of feature amount. The feature amount is derived from voice data that a specific character string is uttered. Then, when recognizing the input voice, this feature amount is used.

Specifically describing, when a user performs a voice input and thus voice recognition processing is started, a feature amount of the user (hereinafter, merely called a user feature amount) is derived from an input voice and compared with each feature amount that is read from the local database 332. Each comparison result of the user feature amount and each feature amount is calculated as a likelihood, and a feature amount corresponding to the largest likelihood is specified. Then, a character string corresponding to the feature amount that is specified is read from the local database 332, and the character string thus read becomes a recognition result. If a user performs a voice input and a character string that is read based on a user feature amount of an input voice is “camera”, for example, a recognition result becomes “camera”.

However, when the largest likelihood is equal to or less than a predetermined value, that is, when an input voice is not registered in the local database, an input voice may be sent to the server 102 to perform voice recognition processing by the server 102. Then, a result of the voice recognition performed by the server 102 is returned to the mobile phone 10. Thus, it is possible to shorten a time until a result of the voice recognition is obtained by performing a part of the voice recognition processing to an input voice using the local database in the mobile phone 10. Furthermore, a burden of the voice recognition processing imposed on the server 102 is also reducible.

FIG. 4 is a schematic view showing a format of use history data indicating a history of an application that a user utilizes with the mobile phone 10. A column of date and time and a column of application name are included in the use history data. A date and time that an application is performed is recorded on the column of date and time. A name of application that is performed is recorded on the column of application name. If an SMS is performed at thirteen nineteen and thirty three seconds, August XX, 20XX, for example, “20XX/08/XX 13:19:33” is recorded in the column of date and time as a character string indicating that date and time, and “SMS” is recorded in the column of application name.

In addition, the character string indicating a date and time, that is, time information is acquired from the RTC 30a. Furthermore, the use history data may be called a user log.

FIG. 5 is a schematic view showing an example of a format of an application table indicating a use frequency of each application. With reference to FIG. 5, a column of category, a column of application name and a column of use frequency are included in the application table. “Camera”, “mail”, etc. are recorded in the column of category as categories of applications being installed. Corresponding to the column of category, a name of an application is recorded in the column of application name. For example, “standard camera” and “AR camera” are recorded as an application corresponding to the category of “camera”, and “E-mail”, “SMS”, and “MMS” are recorded as an application corresponding to the category of “mail”. Corresponding to the column of application name, the number of times (frequency) that the application is performed within a predetermined period (one week, for example) is recorded in the column of use frequency.

For example, the application of “standard camera” that a category is classified into “camera” is started seven (7) times within one week, and the application of “AR camera” is started once within one week. Furthermore, “E-mail” and “MMS” that categories are classified into “mail” are started four (4) times within one week, respectively, and “SMS” is started three (3) times within one week.

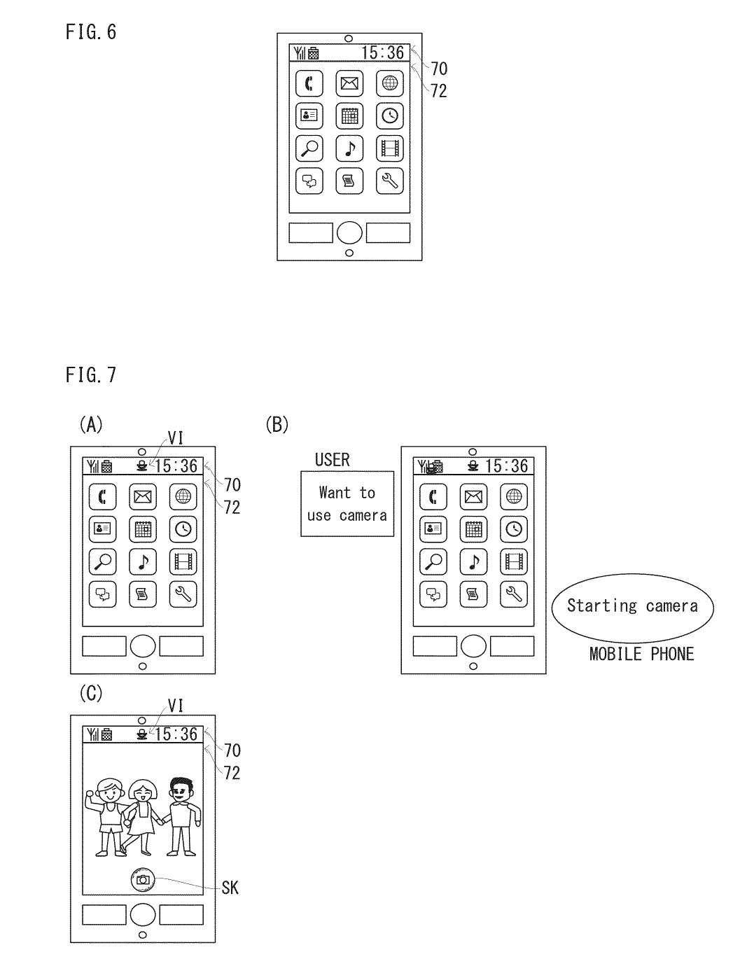

With reference to FIG. 6, the display 14 includes a status display area 70 and a function display area 72, and the function display area 72 is displayed with a standby screen. In the status display area 70, an icon (picto) indicating a radio-wave receiving status by the antenna 34, an icon indicating a residual battery quantity of the secondary battery and a day and time are displayed. In the function display area 72 displays icons for performing an application or changing setting of the mobile phone 10.

Here, if a voice operation function is performed, a voice operation icon VI is displayed in the status display area 70 as shown in FIG. 7(A). As mentioned above, the voice operation function supports a voice input of a natural language. However, in a case of a voice input of the natural language, instructions by a user's voice input may become ambiguous. As an example of an ambiguous voice input, not an application name but a category may be directed like “Use camera”, for example. If such an input is performed, since the “standard camera” and “AR camera” are included in the category of camera, the mobile phone 10 cannot determine which application should be performed.

Therefore, this embodiment deals with an ambiguous voice input based on the use frequency of each application. Specifically, based on the use frequency of each application recorded on the application table, a result of a voice input is narrowed down.

For example, since “camera” is included in the recognition result of voice recognition when a user performs a voice input saying “Use camera” as shown in FIG. 7(B), “camera” is extracted as a search term. If extracting a search term, it is searched whether the search term is included in the application table. Here, since a search term corresponds to “camera” of the category, the content of “camera”, that is, two (2) of “standard camera” and “AR camera” are acquired as the search result (specific information).

Then, when search results are in plural, the search results are narrowed down based on the use frequency corresponding to each application. Here, since the use frequency of “standard camera” is “7” and the use frequency of “AR camera” is “1”, the search term is narrowed down only to “standard camera”. Therefore, the mobile phone 10 starts “standard camera” after outputting a voice message saying “Starting camera”.

With reference to FIG. 7(C), when starting “standard camera”, a through image is displayed on the display 14. Furthermore, an imaging key SK for performing an imaging operation is displayed. Then, imaging processing is performed if a touch operation is performed to the imaging key SK. In addition, the imaging processing can be performed even if a user performs a voice input saying “Imaging” in a state where the imaging key SK is displayed.

Thus, it is possible to increase convenience of a voice operation by narrowing down a search result based on the use history of the user.

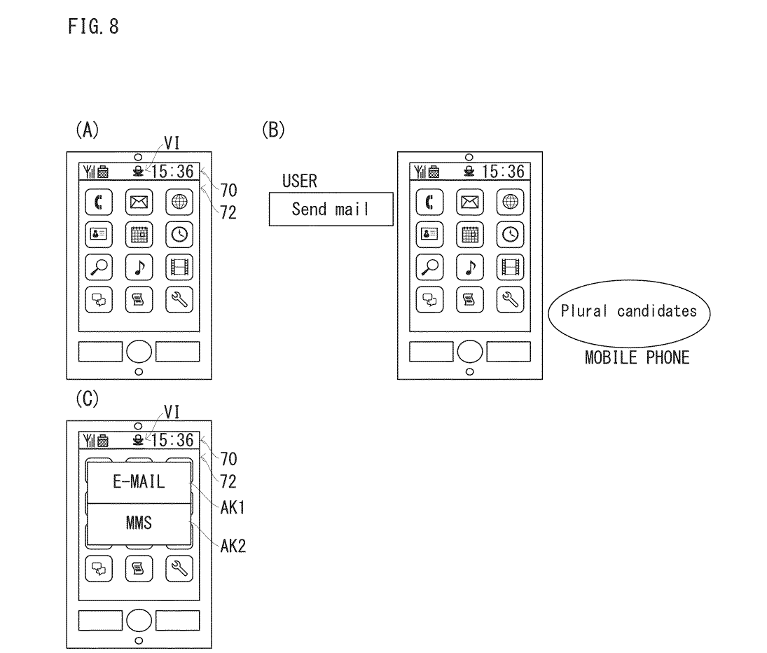

Next, a description will be made about a case where applications that are narrowed down are in plural. With reference to FIGS. 8(A) and 8(B), when a user performs a voice input saying “send mail” in a state where the voice operation function is performed, “mail” is extracted as a search term. Furthermore, based on this search term, three (3) of “E-mail”, “SMS”, and “MMS” are acquired as search results, and they are narrowed down based on the use frequency. However, since the use frequency of each of “E-mail” and “MMS” is the same value and the largest value, it is impossible to narrow-down them to one. Therefore, the mobile phone 10 displays a candidate list of applications on the display 14 after outputting a voice message saying “Plural candidates”.

With reference to FIG. 8(C), a first performing key AK1 for performing an E-mail and a second performing key AK2 for performing an MMS are displayed on the display 14 as the candidate list. Then, the user can use a desired application by operating a performing key AK corresponding to an application that the user wishes to perform in the candidate list being displayed.

Thus, when the search result cannot be narrowed down, it is possible to make the user select an application that the user wish to use by displaying the candidate list.

Furthermore, when an application name is designated by a voice input of the user, an application corresponding to a recognition result is performed. In addition, if the application is terminated within a predetermined time period (15 seconds, for example), a candidate list is displayed based on a second candidate in the recognition result of the voice recognition.

For example, in the recognition result of the voice recognition, when a character string corresponding to the feature amount with the highest likelihood is “SMS” and a character string corresponding to the feature amount with a second highest likelihood is “MMS”, a recognition result becomes as “SMS”, and therefore, an SMS is performed. In this state, if the SMS is terminated within the predetermined time period, “MMS” with a second highest likelihood in the recognition result of the voice recognition is re-acquired as a search term. If a search term is re-acquired, the search term is re-searched in the application table, and an application name of “MMS” is re-acquired as a search result, here. When an application name is re-acquired as a search result, applications of a category that the applications belong is displayed as a candidate list. That is, a candidate list comprising “E-mail”, “SMS” and “MMS” is displayed on the display 14.

Furthermore, if a search result is not acquirable as a result of searching by the search term based on a voice input, that is, if the application corresponding to the search term is not registered in the application table, a browser function is performed. If the browser function is performed, a predetermined search engine site is connected, and a search term is searched in the search engine site. Then, a result that is searched with the search engine site is displayed on the display 14. That is, even if performing a voice input of a word that is not registered in the application table, it is possible to provide information based on the search term to the user.

In addition, a candidate list may be displayed even if the use frequencies of all the applications in the search result are the same value. Furthermore, in other embodiments, even if a difference of the use frequencies of respective applications is equal to or less than a predetermined value (“1”, for example), a candidate list may be displayed.

Furthermore, a voice operation function is performed if the menu key 22c is long-depressed. However, in other embodiments, a software key (icon) for performing a voice operation function may be displayed on the display 14.

Furthermore, a voice saying “No”, “Other” or the like is input at a time that the application is performed, the application being performed is ended. Furthermore, in other embodiments, after the application is ended, the voice operation function may be performed again.

Although the feature of the embodiment is outlined in the above, in the following, the embodiment will be described in detail using a memory map shown in FIG. 9 and flowcharts shown in FIG. 10 and FIGS. 11-13.

With reference to FIG. 9, a program storage area 302 and a data storage area 304 are formed in the RAM 48 shown in FIG. 2. The program storage area 302 is an area for reading and storing (developing) a whole or part of program data that is set in advance in the flash memory 46 (FIG. 2), as described previously.

The program storage area 302 is stored with a use history record program 310 for recording a use history, a voice operation program 312 for operating the mobile phone 10 with a voice input, a voice recognition program 314 for recognizing an input voice, etc. In addition, programs for performing respective applications, etc. are also included in the program storage area 302.

Subsequently, the data storage area 304 of the RAM 48 is provided with a voice recognition buffer 330, and stored with a local database 332, use history data 334 and an application table 336. In addition, the data storage area 302 is provided also with an erroneous determination counter 338.

In the voice recognition buffer 330, data of a voice that a voice input is performed and a result of the voice recognition are temporarily stored. The local database 332 is a database of a format shown in FIG. 3, for example. The use history data 334 is data of a format shown in FIG. 4, for example. The application table 336 is a table of a format shown in FIG. 5, for example.

The erroneous determination counter 338 is a counter for counting a time period after an application is performed by a voice operation. If initialized, the erroneous determination counter 338 starts counting, and expires if a predetermined time period (15 seconds, for example) elapses. Therefore, the erroneous determination counter 340 may be called an erroneous determination timer.

The data storage area 304 is stored with data of a character string that is stored by a copy or cut-out, image data that is displayed in the standby state, etc., and provided with counters and flags necessary for an operation of the mobile phone 10.

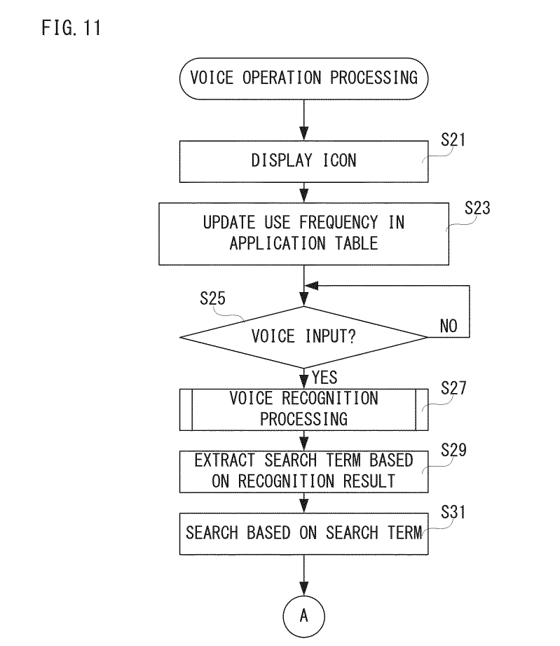

The processor 30 processes a plurality of tasks including use history record processing shown in FIG. 10, voice operation processing shown in FIG. 11-FIG. 13, etc. in parallel with each other under controls of Linux (registered trademark)-base OS such as Android (registered trademark) and REX, or other OSs.

With reference to FIG. 10, use history record processing is started when turning on the power supply of the mobile phone 10. The processor 30 determines, in a step S1, whether an application is performed. For example, it is determined whether an operation for performing an application is performed. If “NO” is determined in the step S1, that is, if no application is performed, the processor 30 repeats the processing of the step S1. On the other hand, if “YES” is determined in the step S1, that is, if an application is performed, the processor 30 acquires a date and time in a step S3, and acquires an application name in a step S5. That is, if an application is performed, a date and time that the application is performed and an application name thereof are acquired. In addition, the date and time is acquired using time information that the RTC 30a outputs.

Subsequently, the processor 30 records a use history in a step S7. That is, the date and time and the application name that are acquired in the above-mentioned steps S3 and S5 are recorded in the application table 336 in association with each other. In addition, after the processing of the step S7 is ended, the processor 30 returns to the processing of the step S1.

FIG. 11 is a flowchart of a part of voice operation processing. If an operation for performing a voice operation function is performed, the processor 30 displays an icon in a step S21. That is, a voice operation icon VI is displayed in the status display area 70. Subsequently, the processor 30 updates a use frequency of the application table in a step S23. That is, a value of the column of use frequency in the application table is updated based on the use frequency of the application that is used within a predetermined period from the present time. Specifically, a numerical value recorded in the column of use frequency in the application table is replaced with “0” once. Then, the use history for the predetermined period that is recorded in the use history data 334 is read, and the use frequency of each application is recorded again in the application table.

Subsequently, the processor 30 determines, in a step S25, whether a voice is input. That is, it is determined whether a voice that the user utters is received by the microphone 20. If “NO” is determined in the step S25, that is, if a voice is not input, the processor 30 repeats the processing of the step S25. If “YES” is determined in the step S25, that is, if a voice is input, the processor 30 performs voice recognition processing in a step S27. That is, a user feature amount is derived from an input voice, and a likelihood with each feature amount is evaluated, and a character string corresponding to a feature amount with the highest likelihood is regarded as a recognition result.

Subsequently, the processor 30 extracts a search term from the recognition result in a step S29. For example, a character string of “camera” is extracted from the recognition result of the voice input as a search term. Subsequently, the processor 30 performs a search based on the search term in a step S31. That is, it is determined whether the search term is included in the application table. Then, if the search term corresponds to either among character strings recorded in the application table, a search result is obtained based on a corresponding character string.

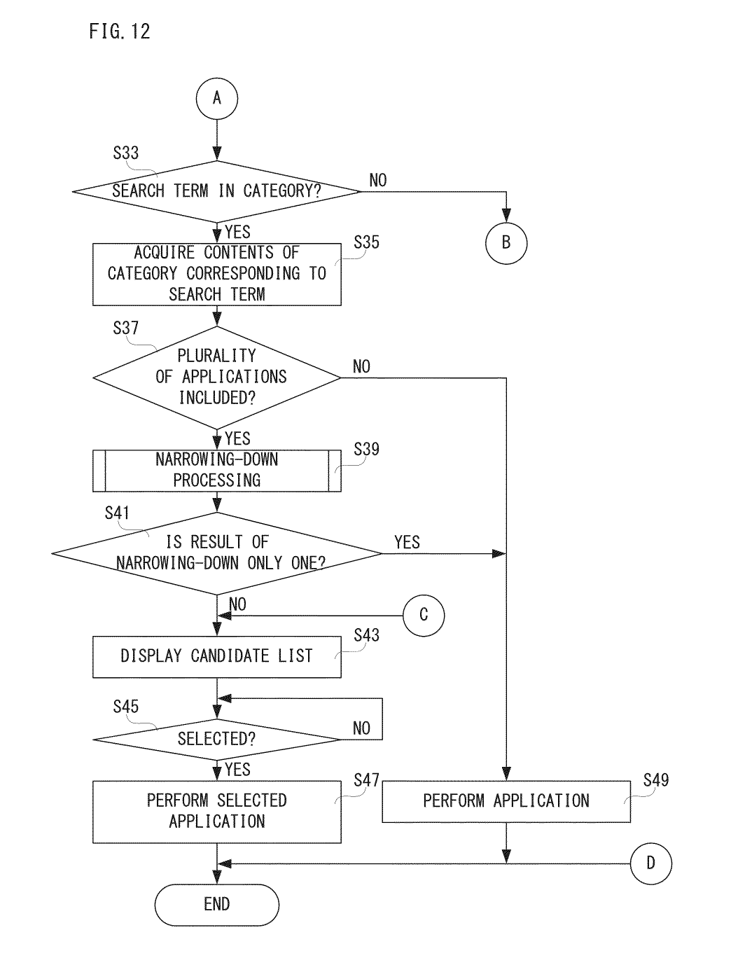

Subsequently, with reference to FIG. 12, the processor 30 determines, in a step S33, the search result is included in the category. That is, the processor 30 determines whether the search term corresponds to the character string in the column of “category” of the application table. If “NO” is determined in the step S33, that is, if the search result is not included in the category, the process proceeds to processing of a step S51.

Furthermore, if “YES” is determined in the step S33, that is, if the search result is “camera”, for example, and thus corresponds to the category of “camera” of the application table, the processor 30 acquires the contents of the category corresponding to the search result in a step S35. For example, “standard camera” and “AR camera” included in the category of “camera” are acquired. In addition, the processor 30 that performs the processing in the step S35 functions as an acquisition module.

Subsequently, the processor 30 determines, in a step S37, whether a plurality of applications are included. That is, the processor 30 determines whether a plurality of applications are included in the contents of the category acquired in the step S35. If “NO” is determined in the step S37, that is, if a plurality of applications are not included in the contents of the category acquired, the processor 30 proceeds to processing of a step S49.

Furthermore, if “YES” is determined in the step S37, that is, if a plurality of applications are included, the processor 30 performs narrowing-down processing in a step S39. That is, based on the use histories corresponding to the plurality of applications, an application with the most use history is selected. Then, a selected application becomes a result of the narrowing-down. In addition, the processor 30 that performs the processing in the step S39 functions as a narrowing-down module.

Subsequently, the processor 30 determines, in a step S41, whether a result of the narrowing-down is only one. That is, the processor 30 determines whether the number of the applications narrowed down based on the use history is one (1). If “YES” is determined in the step S41, that is, if the application narrowed down is only “standard camera”, for example, the processor 30 proceeds to processing of a step S49.

Furthermore, if “NO” is determined in the step S41, that is, if the applications narrowed down are “E-mail” and “MMS”, for example, the processor 30 displays a candidate list in a step S43. As shown in FIG. 8 (C), for example, in order to perform an E-mail and an MMS, respectively, a first performing key AK1 and a second performing key AK2 that the application names are written are displayed on the display 14 as a candidate list. In addition, the processor 30 that performs the processing in the step S43 functions as a display module.

Subsequently, the processor 30 determines, in a step S45, whether an application is selected. That is, it is determined whether an arbitrary application is selected based on the candidate list being displayed. Specifically, the processor 30 determines whether a touch operation is performed to an arbitrary performing key AK in the candidate list being displayed. If “NO” is determined in the step S45, that is, if no application is selected, the processor 30 repeats the processing of the step S45. On the other hand, if “YES” is determined in the step S45, that is, if a touch operation is performed to the first performing key AK1 corresponding to “E-mail”, for example, the processor 30 performs a selected application in a step S47. The function of an E-mail is performed in a step S47, for example. Then, if the processing of the step S47 is ended, the processor 30 terminates the voice operation processing.

Furthermore, if the number of the applications included in the category of the search result is one (1) or if the applications narrowed down by the narrowing-down processing is one (1), the processor 30 performs the application in a step S49. If the application that is narrowed down is “standard camera”, for example, the processor 30 performs a standard camera. Then, if the processing of the step S49 is ended, the processor 30 terminates the voice operation processing.

In addition, the processor 30 that performs the processing in the steps S47 and S49 functions as a performing module.

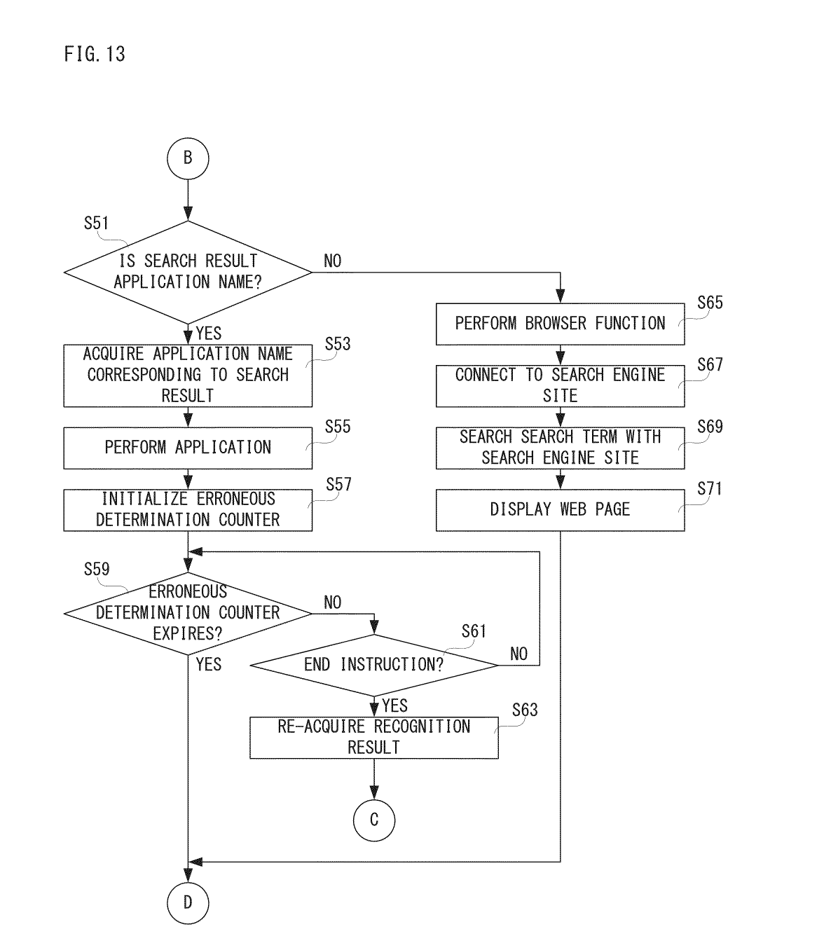

With reference to FIG. 13, if the search result does not correspond to the category, the processor 30 determines, in a step S51, whether the search result is an application name. That is, if “YES” is determined in the step S51, that is, if the search result corresponds to “SMS” in the application table, for example, the processor 30 acquires the application name corresponding to the search result in a step S53. For example, “SMS” is acquired as an application name.

Subsequently, the processor 30 performs the application in a step S55. The SMS is performed based on the application name (“SMS”) that is acquired, for example. Subsequently, the processor 30 initializes the erroneous determination timer in a step S57. That is, in order to measure a time period after the application is performed, the erroneous determination counter 338 is initialized.

Subsequently, the processor 30 determines, in a step S59, whether the erroneous determination timer expires. That is, it is determined whether the predetermined time period elapses after the application is performed. If “NO” is determined in the step S59, that is, if the predetermined time period does not elapse after the application is performed, the processor 30 determines, in a step S61, whether an end is instructed. That is, the processor 30 determines whether there is any voice input or an input operation that ends the application that is performed. If “NO” is determined in the step S61, that is, if an operation that ends the application that is performed is not performed, the processor 30 returns to the processing of the step S59. Furthermore, if “YES” is determined in the step S59, that is, if the predetermined time period elapses after the application is performed, the processor 30 terminates the voice operation processing.

If “YES” is determined in the step S61, that is, if “NO” is input by a voice, for example, the processor 30 re-acquires a recognition result in a step S63. In the step S63, first, the application that is performed is ended. Next, a second candidate in the recognition result of the voice recognition is acquired from the voice recognition buffer 330. Subsequently, the process proceeds to the processing of the step S43, and the processor 30 displays a candidate list. When a recognition result that is re-acquired is “MMS”, for example, the application included in the category that the MMS is classified is displayed on the display 14 as a candidate list in a step S43.

Furthermore, if the search result is not an application name, that is, if the search term is not included in the application table, the processor 30 performs a browser function in a step S65, and connects it to a search engine site in a step S67. In addition, the processor 30 that performs the processing in the step S65 functions as a browser function performing module, and the processor 30 that performs the processing in the step S67 functions as a search module.

Subsequently, the processor 30 searches the search term in the search engine site in a step S69, and displays a web page in a step S71. If the search term is “dinner”, for example, a site containing a character string of “dinner” is searched with the search engine site, and a web page indicating a search result thereof is displayed on the display 14. Then, if the processing of the step S71 is ended, the processor 30 terminates the voice operation processing. In addition, the processor 30 that performs the processing of the step S71 functions as a web page display module.

### Second Embodiment

In the second embodiment, when a browser function is performed by a voice operation, a web page is displayed based on a browsing frequency of a web page of a user. In addition, since basic structure of a mobile phone 10 is approximately the same as that of the first embodiment, a detailed description thereof is omitted.

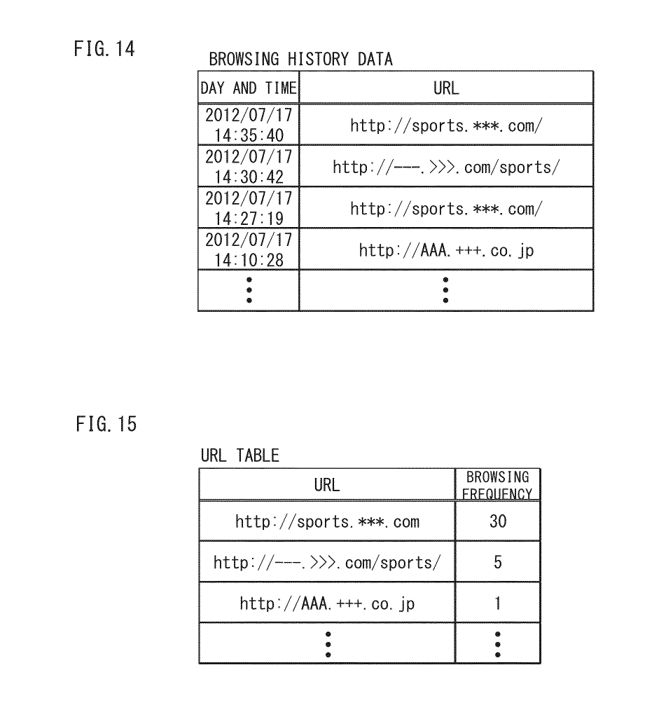

FIG. 14 is a schematic view showing a format of browsing history data of a web page that the user browses by the browser function. With reference to FIG. 14, a column of date and time and a column of URL are included in the browsing history data. A date and time that the web page is browsed is recorded in the column of date and time. A URL corresponding to the web page that is browsed is recorded in the column of URL. If a web page corresponding to “http://sports.***.com/” is displayed on fourteen thirty five and forty seconds on Jul. 17, 2012 by the browser function, for example, “2012/07/17 14:35:40” is recorded in the column of date and time as a character string indicating the date and time at that time, and “http://sports.***.com/” is recorded in the column of URL.

FIG. 15 is a schematic view showing an example of a format of a URL table that the browsing frequency of a web page is recorded. With reference to FIG. 15, the column of URL and the column of browsing frequency are included in the URL table. A column of URL is recorded with a URL of the web page browsed until now. In the column of browsing frequency, corresponding to the column of URL, the frequency that the web page corresponding to the URL to be recorded is browsed within a predetermined period is recorded. According to the URL table shown in FIG. 15, for example, it is understood that the web page corresponding to “http://sports.***.com/” is browsed thirty (30) times within the predetermined period.

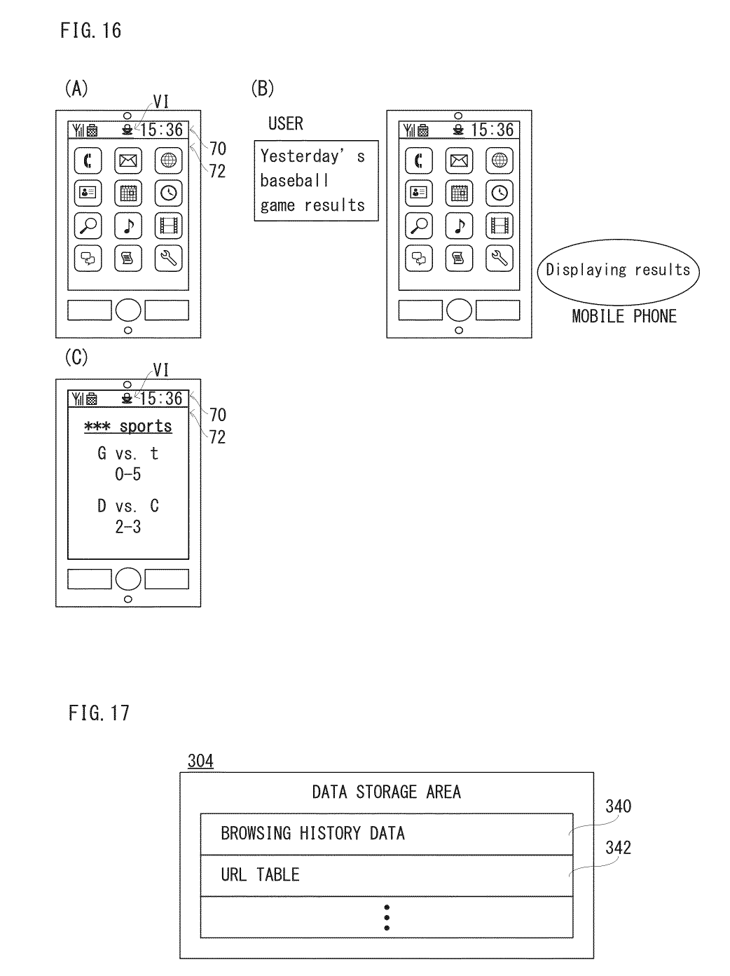

Next, a case where a browser function is performed by a voice input will be described. With reference to FIGS. 16(A) and 16(B), when a user performs a voice input saying “Yesterday's baseball game results” in a state where the voice operation function is performed, “baseball” and “game result” are extracted as a search term. Since two search terms are not included in the application table, the browser function is performed. At this time, a web page with the highest browsing frequency based on the URL table 342 (see FIG. 17) is connected. Then, a search term is searched in a connected web page, and a search result is displayed on the display 14.

With reference to FIG. 16 (C), a game result of yesterday's baseball searched in the web page of “*** sports” with the highest browsing frequency is displayed on the display 14. Thus, based on the browsing frequency of the web page by the user, the search result can be provided.

In addition, when searching a search term with a web page, if a search form is prepared in the page, a search result is acquired using the search form. On the other hand, when a search form is not provided, a link that corresponds to a search term is specified by searching a character string, and a web page of a link destination is acquired as a search result.

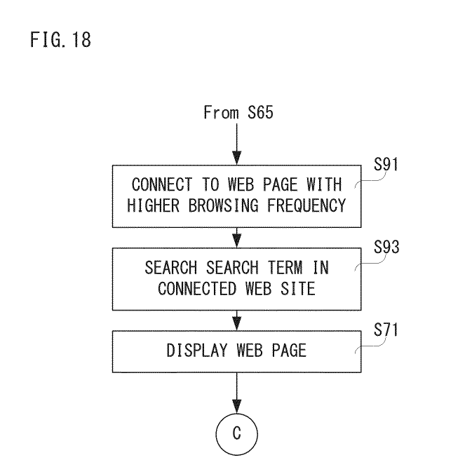

In the above, the feature of the second embodiment is outlined. In the following, the second embodiment will be described in detail using a memory map shown in FIG. 17 and a flowchart shown in FIG. 18.

In the data storage area 304 of the RAM 48 of the second embodiment, browsing history data 340 and a URL table 342 are stored. The browsing history data 340 is data of a format shown in FIG. 14, for example. The URL table 342 is a table of a format shown in FIG. 15, for example.

FIG. 18 is a part of a flowchart of voice operation processing of the second embodiment. In addition, since the steps S21-S65 are the same as those of the first embodiment in the voice operation processing of the second embodiment, a detailed description thereof is omitted.

If a browser function is performed in a step S65, a web page with a high browsing frequency is connected by the processor 30 in a step S91. That is, the URL table 342 is read, and a web page corresponding to a URL with the highest browsing frequency is connected. In the step S91, the web page corresponding to “http://sports.***.com/” is connected based on the URL table 342 shown in FIG. 15, for example.

Subsequently, the processor 30 searches the search term in the web page being connected in a step S93. If the search terms are “baseball” and “game result”, for example, these search terms are searched using a search form, etc. in the web page being connected.

Subsequently, the processor 30 displays the web page in a step S71. As shown in FIG. 16 (C), for example, a result that the search term is searched in the web page with the highest browsing frequency is displayed on the display 14.

In addition, it is possible to arbitrarily combine the first embodiment and the second embodiment with each other and easy to conceive such combination, a detailed description thereof is omitted here.

Furthermore, a category of an application may include “game”, “map”, etc. besides “camera” and “mail”.

Furthermore, when the mobile phone 10 further comprises a GPS circuit and a GPS antenna and thus can perform positioning of a current position, position information may be included in the use history of application. Then, when narrowing-down the search result, this position information may be used. Specifically, after narrowing-down to an application(s) having been performed within a predetermined range from a current position among a plurality of applications, the applications are further narrowed down based on the use history. For example, in a case where an application of a standard camera is mainly used in own home, but an AR camera is mainly used out of the home, if “camera” is performed by a voice operation function outside the home, the AR camera comes to be performed automatically.

Furthermore, in other embodiments, the mobile phone 10 may display a selection screen of two applications on the display 14 when an AR camera and a standard camera are obtained as a result of the narrowing-down processing to the specific information. In such a case, the AR camera is displayed at a higher rank position outside the home while the standard camera is displayed at a position of a lower rank of the AR camera. On the other hand, in own home, the standard camera is displayed at a higher rank position while the AR camera is displayed at a position of a lower rank of the standard camera.

Furthermore, in other embodiments, a color and/or size of a character string indicating an application name may be changed without displaying an application name at a higher rank position.

By processing in such a way, even if a plurality of candidates are displayed, the user can recognize easily which application is an application that should be mainly used in a specific place. That is, the user can easily select the application that is mainly used in the specific place.

Although the mobile phone 10 performs the primary voice recognition processing by providing the local database (dictionary for voice recognition) in the mobile phone 10 and the secondary voice recognition processing is performed by the server 102 in the above-mentioned embodiment, in other embodiments, only the mobile phone 10 may perform the voice recognition processing or only the server 102 may perform the voice recognition processing.

Furthermore, when the mobile phone 10 supports a gaze input, the mobile phone 10 may be operated by a gaze operation in addition to a key operation and a touch operation.

The programs used in the embodiments may be stored in an HDD of the server for data distribution, and distributed to the mobile phone 10 via the network. The plurality of programs may be stored in a storage medium such as an optical disk of CD, DVD, BD or the like, a USB memory, a memory card, etc. and then, such the storage medium may be sold or distributed. In a case where the programs downloaded via the above-described server or storage medium are installed to a portable terminal having the structure equal to the structure of the embodiments, it is possible to obtain advantages equal to the advantages according to the embodiments.

The specific numerical values mentioned in this specification are only examples, and changeable appropriately in accordance with the change of product specifications.

It should be noted that reference numerals inside the parentheses and the supplements show one example of a corresponding relationship with the embodiments described above for easy understanding of the invention, and do not limit the invention.

An embodiment is an information terminal that an operation by a voice input is possible, comprising: a storage module operable to store a plurality of applications and a use history of each of the applications; an acquisition module operable to acquire specific information for specifying an application to be performed based on an input voice; a narrowing-down module operable to narrow down, based on the use history, the specific information that is acquired; and a performing module operable to perform an application based on a result that is narrowed down by the narrowing-down module.

In this embodiment, the information terminal (10: reference numeral exemplifying a portion or module corresponding in the embodiment, and so forth) can be operated by a voice input, and is installed with a plurality of applications. The storage module (48) is a storage media such as a RAM and a ROM, for example, and stores programs of the applications being installed and use histories of the application that the user uses etc. If a user performs a voice input, a recognition result by voice recognition processing is obtained for the input voice. Then, a search term is extracted from the recognition result. When the search term is extracted, an application that can be performed is searched. The acquisition module (30, S35) acquires a result that is thus searched as specific information for specifying the application to be performed. The narrowing-down module (30, S39) narrows down the specific information based on the use history of the application that the user used, for example. The performing module (30, S47, S49) performs an application based on a result that is thus narrowed down.

According to the embodiment, it is possible to increase the convenience of the voice operation by narrowing-down the specific information based on the use history of the user.

A further embodiment further comprises a display module that displays the result that is narrowed down by the narrowing-down module, wherein the performing module performs an application based on a result that is selected when a selection operation is performed to the result that is narrowed down.

In the further embodiment, the display module (30, S43) displays the result that is narrowed down. Then, if the selection operation is performed to the result, the performing module performs an application based on the selection result.

In a still further embodiment, the display module displays results when there are a plurality of results that are narrowed down by the narrowing-down module.

In the still further embodiment, the display module displays a plurality of applications that are narrowed down as a candidate list when the results narrowed down are in plural. Then, the performing module performs an application based on a result of selection if a selection operation is performed to either one among the applications being displayed.

According to the further embodiment and the still further embodiment, when the specific information cannot be narrowed down, it is possible to make a user select an application to be used by displaying the candidate list.

In a yet further embodiment, the display module does not display a result when the result that is narrowed down by the narrowing-down module is one, and the performing module performs an application based on the result that is narrowed down by the narrowing-down module.

A yet still further embodiment further comprises a browsing module that performs a browser function connected to a network when the acquisition module cannot acquire the specific information; a search module that searches a search term based on an input voice using the network connected by the browser function; and a web page display module that displays a web page that is searched by the search module.

In the yet still further embodiment, the information terminal can perform the browser function connected to the network (100). The browsing module (30, S65) performs the browser function when the specific information cannot be acquired. If the browser function is performed, the search module (30, S67) searches the search term based on the input voice with a search engine site that is connected via the network, for example. The web page display module (30, S71) displays the web page that is thus searched.

According to the yet still further embodiment, even if a voice input of the language that is not registered in an application table is performed, it is possible to provide information to a user.

In a further embodiment, a browsing history of a web page is included in the use history, and the web page display module displays a web page based on the browsing history.

In the further embodiment, if the user browses a web page, the browsing history of the web page is recorded. If the browser function is performed by the browsing module, a web page with the highest browsing frequency is connected, and the search term is searched in that web page. Then, the web page display module displays the web page of a result that is thus searched.

According to the further embodiment, it is possible to provide specific information based on the browsing frequency of the web page by the user.

The other embodiment is a voice operation method in an information terminal (10) that comprises a storage module (48) operable to store a plurality of applications and a use history of each of the application, and can be operated by a voice input, a processor (30) of the information terminal performing: acquiring (S35) specific information for specifying an application to be performed based on a voice that is input; narrowing down (S39), based on the use history, the specific information that is acquired; and performing (S47, S49) an application based on a result that is narrowed down.

According to the other embodiment, it is possible to increase convenience of the voice operation by narrowing down the specific information based on a user use history.

### DESCRIPTION OF NUMERALS

10—portable phone
14—display
16—touch panel
30—processor
30a—RTC
42—input device
46—flash memory
48—RAM
100—network
102—server

1. An information terminal that an operation by a voice input is possible, comprising:
a storage module operable to store a plurality of applications and a use history of each of the applications;
an acquisition module operable to acquire specific information for specifying an application to be performed based on an input voice;
a narrowing-down module operable to narrow down, based on the use history, the specific information that is acquired; and
a performing module operable to perform an application based on a result that is narrowed down by the narrowing-down module.

2. The information terminal according to claim 1, further comprising a display module that displays the result that is narrowed down by the narrowing-down module, wherein
the performing module performs an application based on a result that is selected when a selection operation is performed to the result that is narrowed down.

3. The information terminal according to claim 2, wherein the display module displays results when there are a plurality of results that are narrowed down by the narrowing-down module.

4. The information terminal according to claim 2, wherein the display module does not display a result when the result that is narrowed down by the narrowing-down module is one, and
the performing module performs an application based on the result that is narrowed down by the narrowing-down module.

5. The information terminal according to claim 1, further comprising:
a browsing module that performs a browser function connected to a network when the acquisition module cannot acquire the specific information;
a search module that searches a search term based on an input voice using the network connected by the browser function; and
a web page display module that displays a web page that is searched by the search module.

6. The information terminal according to claim 5, wherein a browsing history of a web page is included in the use history, and the web page display module displays a web page based on the browsing history.

7. A voice operation method in an information terminal that comprises a storage module operable to store a plurality of applications and a use history of each of the application, and can be operated by a voice input, a processor of the information terminal performing:
acquiring specific information for specifying an application to be performed based on a voice that is input;
narrowing down, based on the use history, the specific information that is acquired; and
performing an application based on a result that is narrowed down.
